(19) United States
(12) Patent Application Publication
(10) Pub. No.: US 2008/0085449 A1
(43) Pub. Date: Apr. 10, 2008

(54) Ultra-Miniature Electrochemical Cell And Fabrication Method

(75) Inventors: Michael Pyszczek, Leroy, NY (US); Robert Zayatz, North Tonawanda, NY (US)

Correspondence Address: WALTER W. DUFT;LAW OFFICES OF WALTER W. DUFT, 8616 MAIN ST, SUITE 2, WILLIAMSVILLE, NY, 14221, US

(73) Assignee: GENTCORP LTD., Lancaster, NY (US)

(21) Appl. No.: 11/539,771

(22) Filed: Oct. 9, 2006

(51) Int. Cl. H01M 2/14; H01M 6/00

(52) U.S. Cl. 429/129; 29/623.1

(57) ABSTRACT

An ultra-miniature electrochemical cell and related fabrication method. The cell includes a cell case having a first cell electrode attached to an inside wall thereof. An electrode-header assembly is also disposed in the cell case. The electrode-header assembly includes an electrode plug providing a second cell electrode, a header assembly attached to the cell case, and a current collector embedded in the electrode plug and extending through the header assembly. The cell further includes an electrolyte-carrying separator disposed in cell case between the first and second electrodes. Advantageously, the second cell electrode may be fabricated using a punching process and joined to the current collector while constrained within tooling in order to minimize the risk of damage to the electrode during handling. This method facilitates the efficient, repeatable fabrication of small uniform electrodes and subsequent attachment of the electrodes to their associated current collectors. The method thus enables the production of electrodes having single millimeter thicknesses or less. Moreover, the method is compatible with many primary cell electrode materials, thereby allowing the production of primary power sources having a form factor and dimensions suitable for percutaneous injection.

### BACKGROUND OF THE INVENTION

1. Field of the Invention

The present invention relates to electrochemical cells and, more particularly, to cells with a very small form factor.

2. Description of Prior Art

Electrochemical cells of small size have been utilized for many applications. For example, miniature cells and batteries that utilize an alkali metal anode (such as lithium), a cathode, and a non-aqueous electrolyte have been widely used to power implantable medical devices, such as pacemakers. Such cells have been manufactured in a variety of shapes and sizes. In instances where the finished cell is to take the form of a cylinder, the electrode couple comprising anode, cathode and electrolyte materials may be fabricated as a thin, flat ribbon laminate that is rolled before insertion into the cell (jelly-roll). According to an alternative fabrication technique, cathode material may be formed into a hollow cylindrical bobbin that is inserted within a metal enclosure. Electrolyte material and complementary anode materials are also formed into cylinders that are placed into the open center of the cathode structure. A current collector sleeve is subsequently inserted into the center of the anode material to provide the cell's anode electrical connection (with the case providing the cathode electrical connection). This latter method of construction for cylindrical cells has been practiced for many years in the manufacture of commercially available dry cells sold in industry standard sizes designated as D, C, AA, AAA and AAAA batteries. The smallest of these standard cells has the designation of AAAA, with a diameter of 8 millimeters and a length of 42 millimeters.

When utilized in implantable medical applications, the overall size of a battery cell is often of primary importance because of the volume that the cell occupies within the organism. More recently, there has been a need for implantable cylindrical cells with exceptionally small dimensions in order to allow implantation by means of percutaneous injection, rather than more traditional surgical implantation. Implantation by injection is much less invasive than surgery, with a corresponding reduced risk of complications after the implantation procedure. A cell that is suitable for injection as part of a medical device should preferably have a diameter of less than 4 millimeters, and most preferably a diameter of 2 millimeters or less.

As the overall dimensions of the cell are reduced, the dimensions of the individual cell components must also be reduced in proportion. This is a challenge when using high energy density cathode materials such as carbon monofluoride (CFₓ), manganese dioxide (MnO₂) and silver vanadium oxide (SVO). Such materials are commonly used in conjunction with alkali metal (e.g., lithium) anodes for primary cells intended for implantable medical use. Whereas cylindrical cell electrodes made from such cathode materials are typically fabricated by extrusion, shearing and drying, these methods are unsuitable when the finished cathode diameter is less than a few millimeters because of the difficulty in maintaining uniform material density and the delicate nature of the resulting components. The handling problems are compounded by the need to attach the cathode to a current collector pin or wire after shearing. While the fabrication techniques described in the prior art are suitable for traditional cylindrical cells, they are not readily applied to the fabrication of extremely small cell electrode structures.

It is to improvements in the fabrication and manufacture of small form factor electrochemical cells that the present invention is directed. In particular, what is needed is an improved technique for fabricating cathode electrode structures without the attendant disadvantages of the prior art approaches described above.

### SUMMARY OF THE INVENTION

The foregoing problems are solved and an advance in the art is provided by an ultra-miniature electrochemical cell and related fabrication method. The cell includes a cell case having a first cell electrode attached to an inside wall thereof. An electrode-header assembly is also disposed in the cell case. The electrode-header assembly includes an electrode plug providing a second cell electrode, a header assembly attached to the cell case, and a current collector embedded in the electrode plug and extending through the header assembly. The cell further includes an electrolyte-carrying separator disposed in cell case between the first and second electrodes. Advantageously, the second cell electrode may be fabricated using a punching process and joined to the current collector while constrained within tooling in order to minimize the risk of damage to the electrode during handling. This method facilitates the efficient, repeatable fabrication of small uniform electrodes and subsequent attachment of the electrodes to their associated current collectors. The method thus enables the production of electrodes having single millimeter thicknesses or less. Moreover, the method is compatible with many primary cell electrode materials, thereby allowing the production of primary power sources having a form factor and dimensions suitable for percutaneous injection.

### BRIEF DESCRIPTION OF THE DRAWINGS

The foregoing and other features and advantages of the invention will be apparent from the following more particular description of preferred embodiments of the invention, as illustrated in the accompanying Drawings (which are not necessarily to scale) in which:

FIG. 1 is a cross-sectional center-line view of a finished cell constructed in accordance with the fabrication method disclosed herein;

FIG. 2 is a flowchart illustrating exemplary operations that may be used to fabricate an electrode and header assembly of the cell shown in FIG. 1, and;

FIG. 3A is a perspective view showing an electrode sheet and a form punch prior to removing an electrode plug from the electrode sheet;

FIG. 3B is a perspective view showing an electrode sheet and a form punch subsequent to removal of an electrode plug from the electrode sheet;

FIG. 3C is a perspective view showing a form punch carrying an electrode element and a current collector feed-through assembly prior to insertion in the electrode element;

FIG. 3D is a perspective view showing a form punch carrying an electrode element following insertion of a current collector assembly therein;

FIG. 3E is a perspective view showing the ejection of an electrode element from a form punch; and

FIG. 3F is a perspective view showing the mounting of an electrolyte-carrying separator on an electrode plug and the mounting of an electrode-header assembly in a cell case.

### DETAILED DESCRIPTION OF EXEMPLARY EMBODIMENTS

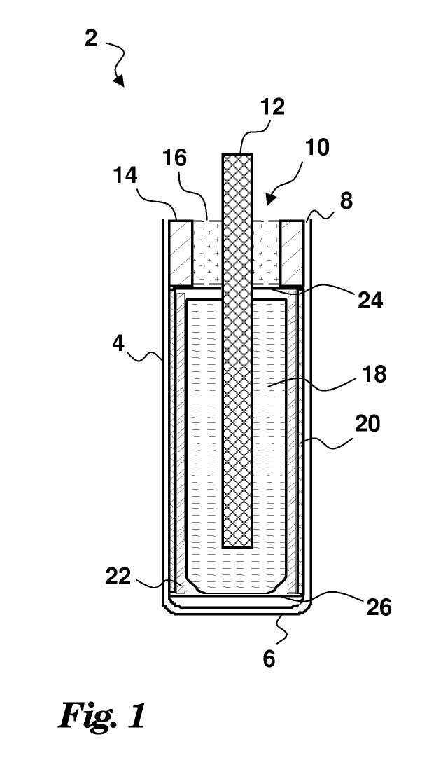

Turning now to the Drawings, wherein like reference numerals signify like elements in all of the several views, FIG. 1 illustrates an exemplary electrochemical cell 2 that may be constructed in accordance with the fabrication method disclosed herein. The cell 2 includes a case 4 whose configuration is that of a cylinder with one closed end 6 and one open end 8. The case 4 may be fabricated from titanium, stainless steel or any other suitable electrically conductive material. The open end 8 of the cell case 4 is sealed by a current collector header assembly 10 that comprises a current collector pin 12 sealed within an annular metal ring 14 by way of a glass seal 16. The annular ring 14 may be welded to the perimeter of the case open end 8 to provide a hermetic enclosure for the cell contents. The current collector pin 12 provides an electrical connection to a cathode structure 18 within the case 4. A cell anode 20 having a tubular shape is swaged against the inside wall of the cell case 4 to provide an electrical connection to the case material. The cathode 18 and the anode 20 are separated by a permeable non-conductive electrolyte separator 22 that is wrapped entirely around the cathode before the cell 2 is assembled. A small non-conductive washer 24 is interposed between the cathode 18 and the feed-through assembly 10. The washer 24 serves as an insulator to prevent the cathode 18 from coming in contact with the annular ring 14 of the feed-through assembly 10, which would cause a short-circuit. Another non-conductive washer 26 is interposed between the cathode 18 and the bottom of the cell case 4.

Using the fabrication method to be described hereinafter, the cell 2 can be made with an ultra-miniature (e.g., approximately 4 millimeters or less in width) form factor. By way of example, the outside diameter of the cell 2 may be 2 millimeters and the height of the cell, excluding the current collector pin 12, may be 6 millimeters. With this form factor, the required diameter for the cathode 18 is approximately 1½ millimeters, which is much smaller than would be required for even the AAAA cell described by way of background above. In addition, the current collector pin 12 must be inserted into the cathode 18 without damaging or deforming the cathode. It is also necessary to physically secure the cathode 18 to the current collector pin 12 while providing a reliable electrical connection.

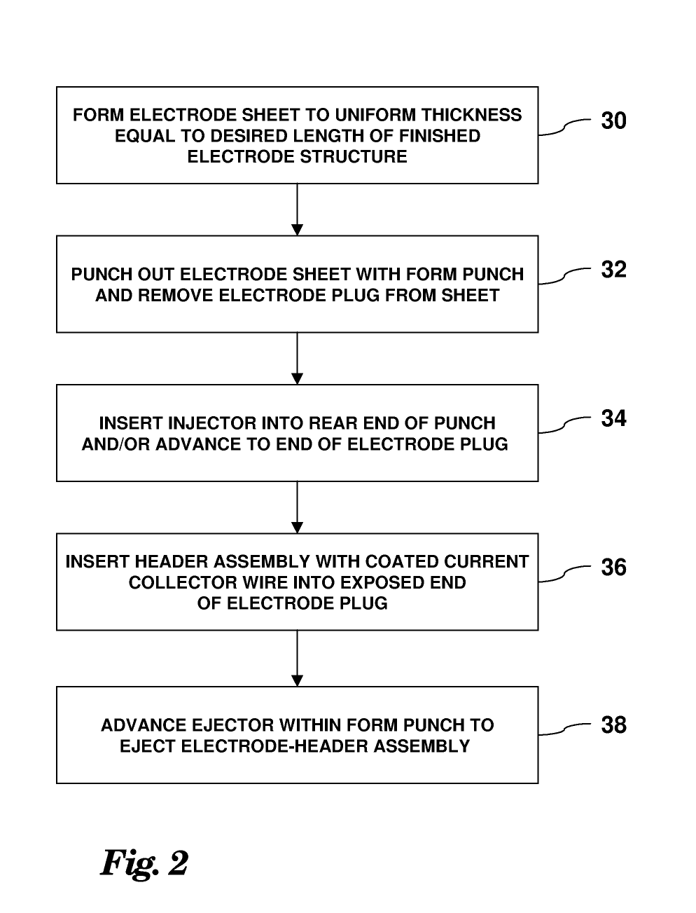

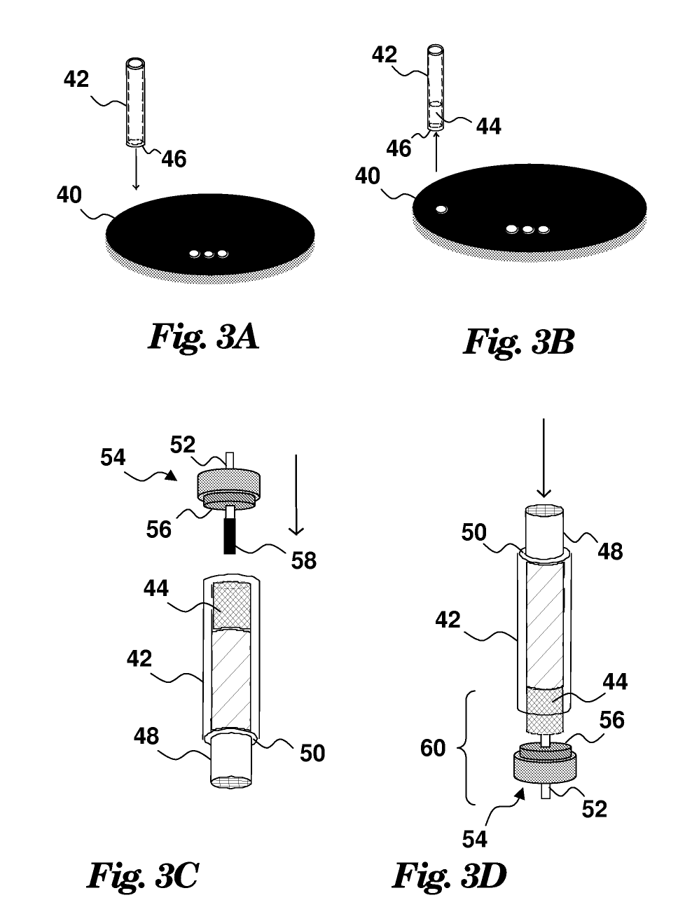

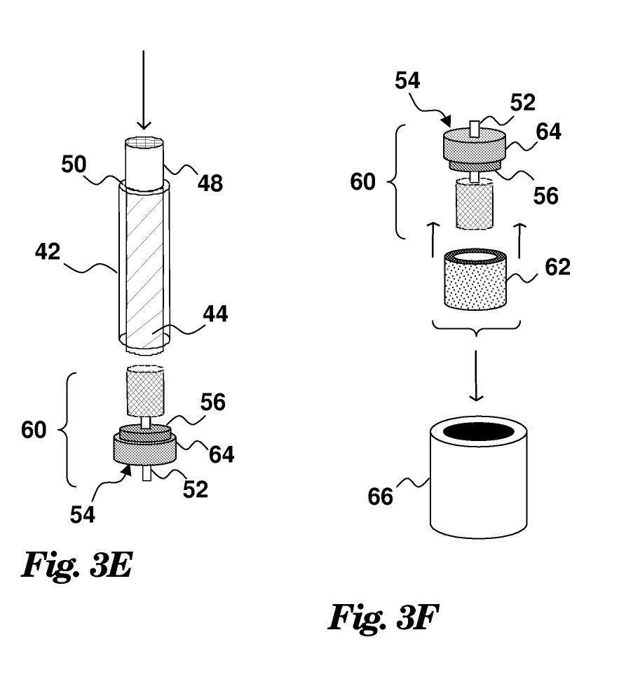

Referring now to FIGS. 2-4, the cell 2 may be fabricated using a sequence of operations 30-38 that allow the size of the cell to be greatly reduced as compared to cells made using conventional techniques. According to a first operation 30 of FIG. 2, an electrode compound comprising a desired electrode material (e.g., a cathode material) is mixed with a solvent to produce a paste and pressed or rolled to an electrode sheet 40 (see FIGS. 3A and 3B) having a thickness equal to the desired length of the finished electrode (e.g., the cathode 18 of FIG. 1). By way of example, if a CFx cathode is desired, a fluorinated carbon produced through the direct fluorination of a carbon material, such as petroleum coke, is uniformly mixed with acetylene black carbon to increase the electrical conductivity of the final cathode mixture. A PTFE emulsion, where the PTFE content is 60% in an aqueous suspension, may be added to the cathode admixture to act as an inert binder. The resulting cathode mixture may have 86.2% of the cathode active material, 8.6% acetylene black and 5.2% solid PTFE. An additional liquid phase comprising a 1:1 ratio of isopropyl alcohol and water may be added to the mixture in a quantity representing 10% by weight of the total admixture. The cathode mixture may be intimately blended by means of a mortar and pestle and pressed to a desired thickness (corresponding to the desired length of the electrode, or some fraction thereof (see below)) and then dried at 80° C. for a period of 16 hours to form the electrode sheet 40.

According to a second operation 32 of step 2, a form punch 42 (see FIGS. 3A-3B) or other suitable tool may be used to cut and extract individual electrode plugs 44 (e.g., corresponding to the cathode 18 of FIG. 1) from the electrode sheet 40 (see FIG. 3B). The form punch 42 is a hollow structure having a sharp cutting end 46. By way of example only, the form punch 42 may have a tubular configuration in order to produce electrode plugs that are cylindrical in shape, with the inside diameter of the form punch being equal to the outside diameter of the finished electrode (e.g., the cathode 18 of FIG. 1). The length of the finished electrode will be determined by the thickness of the formed electrode sheet 40. In some cases, the electrode sheet 40 may be thick enough so that only a single electrode plug is required. In other cases, the electrode sheet 40 may not be thick enough to provide the required electrode length because there is a finite maximum thickness to which any electrode material (such as CFx) can be formed. In that case, applications requiring a long small-diameter electrode may be satisfied by extracting two or more electrode plugs from the electrode sheet 40 and successively pressing them onto a current collector pin (see below). The electrode plugs 44 can be excised from the electrode sheet 40 by pressing the form punch 42 into the electrode sheet (as shown in FIG. 3A) until the cutting end 46 pierces the entire thickness of the sheet. When the form punch 42 is removed from the electrode sheet 40, the electrode plug 44 will be captured within the form punch interior, as shown in FIG. 3B. The form punch 42 thus provides a convenient means to handle and manipulate the electrode plug 44 while protecting it from damage during subsequent processing.

According to a third operation 34 of FIG. 2 (and as shown in FIG. 3C), an ejector pin 48 is inserted into a back end 50 of the form punch 42. Alternatively, the ejector pin 48 may have been previously inserted into the form punch 42. It could also be permanently mounted on the form punch 42 (e.g., as a spring-loaded plunger). The ejector pin 48 supports the electrode plug 44 against movement during a fourth operation 36 of FIG. 2 in which a current collector pin 52 of a header assembly 54 (e.g., corresponding to the header assembly 10 of FIG. 1) is inserted in the electrode plug's exposed end (see FIG. 3C). Prior to operation 36, an insulating washer 56 (corresponding to the insulating washer 24 of FIG. 1) may be installed on the current collector pin 52. The electrode-engaging end of the current collector pin 52 is preferably coated with a first coat of a conductive protective material 58, such as Acheson Industries EB-020A chemical-resistant thermosetting material, in order to protect the pin from corrosion. After the first coat of the conductive material 58 is cured, a second coating of the conductive material may be applied to the current collector pin 52 immediately prior to operation 36. This enhances the thickness of the protective layer and improves the adhesion of the current collector pin 52 to the electrode plug 44. The result of operation 36 is to create a consolidated electrode-header assembly 60 that comprises the electrode plug 48 and the header assembly 54 interconnected by way of the current collector pin 52 (see FIG. 3D).

According to a fifth operation 38, the ejector pin 48 is advanced within the form punch 42 to eject the electrode-header assembly 60 (as shown in FIGS. 3D-3E). The ejected electrode-header assembly 60 is subsequently dried at elevated temperature in order to remove residual solvents and moisture before further assembly. After drying and prior to insertion of the electrode-header assembly 60 into a cell case (e.g., the cell case 4), the electrode plug 44 is wrapped with a separator material 62 (e.g., corresponding to the separator 22 of FIG. 1) that maintains a physical separation between the electrode and anode electrodes when the resultant cell is assembled. An electrolyte material is then introduced into the separator 62. The quantity of electrolyte is a matter of design choice, but is preferably approximately ten times the weight of the electrode plug 44. As shown in FIG. 3F, following the introduction of the electrolyte into the separator 62, the electrode-header assembly 60 is inserted into the open end of a cell case 66 (e.g., corresponding to the cell case 4). The header assembly's annular ring 64 is then welded to the perimeter of the open end of the cell case 66 to provide a hermetic enclosure for the cell contents. If desired, the electrolyte-carrying separator 62 could be placed in the cell case 66 prior to the electrode-header assembly. However, it will usually be more expedient to mount the separator 62 on the electrode plug 44 as part of the electrode-header assembly 60 prior to introducing the assembly into the cell case 66.

Exemplary electrochemical cells that may be constructed in accordance with the fabrication method disclosed herein include cells having an anode comprising an alkali metal, such as a lithium, a cathode comprising a material such as carbon monofluoride (CFₓ), manganese dioxide (MO₂) and silver vanadium oxide (SVO), and an electrolyte comprising a lithium salt (e.g., LiBF₄) dissolved in a non-aqueous solvent, such as a y-butyrolactone. The separator material 62 may comprise a micro-porous polypropylene material. Electrochemical cells constructed using the foregoing chemistries exhibit high volumetric energy density, low to medium rate discharge capability, and low self-discharge. These characteristics make such cells a desirable choice for implantable medical applications where long service life with low average discharge rate is of paramount importance. Other anode and cathode materials may also be used. The method disclosed herein is thus widely applicable to the fabrication of very small cylindrical electrodes formed from many different compounds and materials.

Accordingly, an ultra-miniature electrochemical cell and fabrication method have been disclosed. Advantageously, one of the cell electrodes may be fabricated using a punching process and joined to a current collector while constrained within tooling in order to minimize the risk of damage to the electrode during handling. This method facilitates the efficient, repeatable fabrication of small uniform electrodes and subsequent attachment of the electrodes to a current collector. The disclosed fabrication method facilitates the production of electrodes having single millimeter thicknesses or less. Moreover, the method is compatible with many primary cell electrode materials, thereby allowing the production of primary power sources having a form factor and dimensions suitable for percutaneous injection.

It should, of course, be understood that the description and the drawings herein are merely illustrative, and that the various modifications, combinations and changes can be made in accordance with the invention. For example, the fabrication method could be used to form an anode-header assembly in which an anode plug is attached to a header assembly by way of a current collector pin. It will be understood, therefore, that the invention is not to be in any way limited except in accordance with the spirit of the appended claims and their equivalents.

What is claimed is:

1. An ultra-miniature electrochemical cell, comprising:
a cell case;
a first cell electrode attached to an inside wall of said cell case; and
an electrode-header assembly in said cell case, said electrode-header assembly including:
an electrode plug providing a second cell electrode;
a header assembly attached to said cell case; and
a current collector embedded in said electrode plug and extending through said header assembly;
said cell further including an electrolyte-carrying separator disposed in said cell case between said first electrode and said second electrode.

2. An electrochemical cell in accordance with claim 1, wherein said electrolyte-carrying separator is mounted to said electrode plug as part of said electrode-header assembly.

3. An electrochemical cell in accordance with claim 1, wherein said cell case includes a closed end and an open end, and said header assembly is disposed at said open end.

4. An electrochemical cell in accordance with claim 1, wherein said first cell electrode comprises an anode and said second cell electrode comprises a cathode.

5. An electrochemical cell in accordance with claim 1, wherein said header assembly comprises an outer ring attached to said cell case and an inner seal that receives said current collector.

6. An electrochemical cell in accordance with claim 5, wherein said electrode-header assembly further includes an insulative washer on said current collector between said electrode plug and said header assembly.

7. An electrochemical cell in accordance with claim 1, wherein said current collector comprises one or more conductive coatings at locations where said current collector is embedded in said electrode plug.

8. An electrochemical cell in accordance with claim 1, wherein said separator comprises a micro-porous material wrapped around said electrode plug.

9. An electrochemical cell in accordance with claim 1, wherein said electrode-header assembly comprises plural electrode plugs having said current collector embedded therein.

10. An electrochemical cell in accordance with claim 1, wherein said first electrode comprises a lithium anode and said second electrode comprises a fluorinated carbon cathode.

11. A method for fabricating an ultra-miniature electrochemical cell, comprising:
attaching a first cell electrode to a cell case;
forming an electrode sheet having a thickness corresponding to a desired length of a second cell electrode;
extracting an electrode plug from said electrode sheet using a form punch having a hollow interior and a cutting edge adapted to cut through said electrode sheet;
attaching a header assembly to said electrode plug to form an electrode-header assembly having a current collector embedded in said electrode plug and extending through said header assembly;
ejecting said electrode-header assembly from said form punch;
inserting said electrode-header assembly into said cell case; and
attaching said header assembly to said cell case.

12. A method in accordance with claim 11, further including placing an electrolyte-carrying separator on said electrode plug prior to ejecting said electrode-header assembly from said cell case.

13. A method in accordance with claim 11, wherein said cell case includes a closed end and an open end, and said header assembly is disposed at said open end.

14. A method in accordance with claim 11, wherein said first electrode comprises an anode and said second electrode comprises a cathode.

15. A method in accordance with claim 11, wherein said header assembly comprises an outer ring adapted for attachment to said cell case and an inner seal that receives said current collector.

16. A method in accordance with claim 15, wherein said electrode-header assembly further includes an insulative washer on said current collector between said electrode plug and said header assembly.

17. A method in accordance with claim 11, wherein said current collector comprises one or more conductive coatings at locations where said current collector is embedded in said electrode plug.

18. A method in accordance with claim 11, wherein said separator comprises a micro-porous material wrapped around said electrode plug.

19. A method in accordance with claim 11, wherein said electrode-header assembly is formed with plural electrode plugs having said current collector embedded therein.

20. A method in accordance with claim 11, wherein said first electrode comprises a lithium anode and said second electrode comprises a fluorinated carbon cathode.

21. A method for fabricating an ultra-miniature primary electrochemical cell, comprising:
attaching a first electrode to a cell case having a closed end and an open end;
forming an electrode sheet having a thickness corresponding to a desired length of a second cell electrode;
extracting an electrode plug from said electrode sheet using a form punch having a hollow interior and a cutting edge adapted to cut through said electrode sheet;
attaching a header assembly to said electrode plug to form an electrode-header assembly having a current collector embedded in said electrode plug and extending through said header assembly;
wrapping an electrolyte-carrying separator around said electrode plug;
ejecting said electrode-header assembly from said form punch;
inserting said electrode-header assembly into said cell case; and
attaching said header assembly to said cell case open end;
said first electrode comprising a lithium anode and said second electrode comprising a fluorinated carbon cathode;
said header assembly comprising an outer ring adapted for attachment to said cell case and an inner seal that receives said current collector;
said electrode-header assembly further including an insulative washer on said current collector between said electrode plug and said header assembly; and
said current collector comprising one or more conductive coatings at locations where said current collector is embedded in said electrode plug.
